(19) United States
(12) Patent Application Publication
(10) Pub. No.: US 2007/0006479 A1
(43) Pub. Date: Jan. 11, 2007

(54) Water-based heater for an electric clothes dryer

(76) Inventor: Rafael Antonio Salgado-Mangual, Carolina, PR (US)

Correspondence Address: RAFAEL ANTONIO SALGADO-MANGUAL, PARQUE ECUESTRE, CAMARARO B-11, CAROLINA, PR, 00987, US

(21) Appl. No.: 11/177,373

(22) Filed: Jul. 11, 2005

(51) Int. Cl. F26B 11/02; D06F 58/00

(52) U.S. Cl. 34/134; 34/108

(57) ABSTRACT

Looking a solution for appliances that consumes large amount of electric energy in houses, Solar energy appears to be more suitable for the application. One of the most consuming household appliances is the clothes dryer. Implementing a heat exchanger inside the machine, the electric resistance that heats the air can be substituted, lowering the electric cost and environmental risks. This can be done with a solar water heater, converting solar radiation into useful heat. A compact heat exchanger has been design to provide the 1500 W that the electric resistance supplies to the clothes dryer in order to dry clothes. Nevertheless, Other design can be suitable for the application.

### BACKGROUND OF THE INVENTION

In the conventional Clothes Dryer appliance, the heat source that promotes the drying of the clothes as they tumble in a rotating drum has traditionally been an electrical coil. Such coils generate heat by presenting high resistance to the electrical current in the appliance's electrical circuit and thereby consume a very significant amount of electricity. So significant is the amount of electricity that these heating coils use to generate the required heat, it makes the Dryer one of the major consumers of electricity in the average home.

One of the tragic characteristics of modern societies is the extensive use of fossil fuel. Much of this fossil fuel is used to generate electricity to meet the electrical needs of homes but so polluting are the processes whereby the energy in such fuel is converted into electricity, we pay a very high price in terms of healthcare costs and reduced life expectancy because of the respiratory illness, carcinogenic and other negative effects of the environmental pollution resulting from our extensive use of fossil fuel. What makes this tragedy inexcusable is the fact that all our energy needs may be adequately met with the effective use of renewable energy.

As we address the subject of renewable energy utilization, it readily becomes evident that Solar Power Conversion mechanisms offer outstanding promise for the effective application of the environmentally clean energy from the sun. As was patently demonstrated by the completed Solar Decathlon in Washington D.C., all the electrical needs of a house may be more than adequately met with non-polluting Solar Energy.

### BRIEF SUMMARY OF THE INVENTION

Because in the average home, a significant amount of the energy consumed is used for heating water to create a hot water supply source and, in a solar powered home, electricity has to be efficiently managed for optimal results, rather than use the photo element of the sun's radiation to produce electricity and then use that electricity to heat water, a much more efficient approach is to utilize the heat element of the sun's radiation to heat water directly and thereby free up the photon based electricity to address other non-thermal electrical needs of the house and its occupants.

Because of the excessive electrical demands of the traditional heating coil in the conventional clothes dryer, the objective of this invention is to eliminate the heating coil in the Dryer and utilize solar radiation heated water to provide the heat required for the drying of clothes, this being accomplished by implementing a heat exchanger inside the Dryer.

### BRIEF DESCRIPTION OF THE SEVERAL VIEWS OF THE DRAWING

FIG. 1

Blower—Electric resistance configuration of electric clothes dryer.

FIG. 2

Proposed Blower—Heat Exchanger—Electric resistance configuration.

FIG. 3

Closed loop configuration of the system. Main elements are shown.

FIG. 4

Back up electric resistance inside the air conduit. Zoomed view of the electric resistance.

FIG. 5

Assembly of the improvement inside the machine. Just to illustrate one possible configuration of the blower, heat exchanger and electric resistance. The heat exchanger configuration is counter flow heat exchanger.

FIG. 6

Design of the heat exchanger. Sectional views, dimensions and isometric view of the heat exchanger is shown.

### DETAILED DESCRIPTION OF THE INVENTION

As we all know, the Clothes Dryer is one of the most expensive and most electric energy-consuming household appliances these days. This is because of the heating element that the machine uses to heat the air. This element draws as much as 1500 W of electric energy in order to heat the air, meaning a lot of money in kilowatts per year. To reduce costs, electric energy consumption and, to make this appliance available to everybody the following modification has been made to an electric clothes dryer.

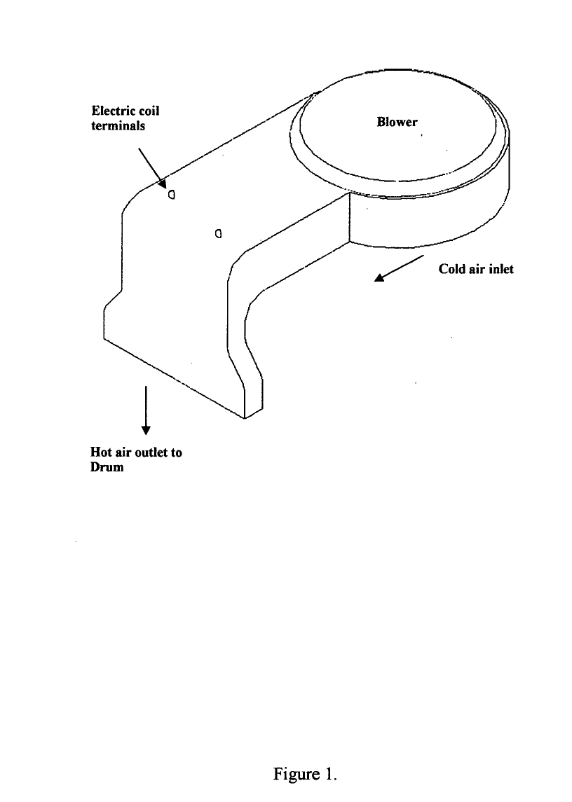

In the common Electric Clothes Dryer the blower forces the air through the electric coil or electric resistance, heating the air through direct contact. The electric coil is mounted in the air conduit that goes into the tumbling drum of the clothes dryer as shown in FIG. 1. It is plugged into the electric circuit of the house and draws energy to produce heat. This process is where a large amount of electricity is consumed.

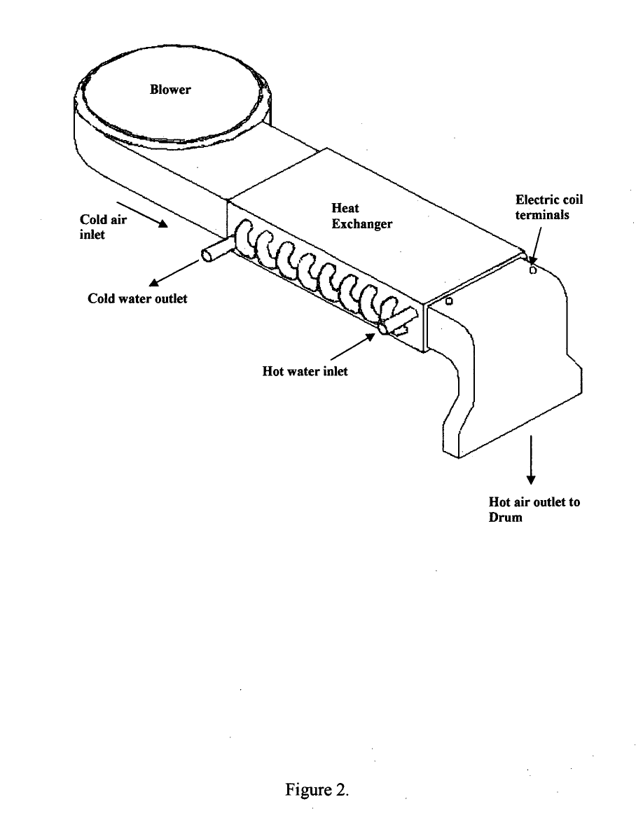

The invention consists on adding a heat exchanger in the blower-resistance configuration to heat the air (FIG. 2). This way the air will be heated with hot water instead of electric energy. The Water will be heated by Gas Heaters or Boilers in Housing Buildings or by Residual Heats on Industrial processes.

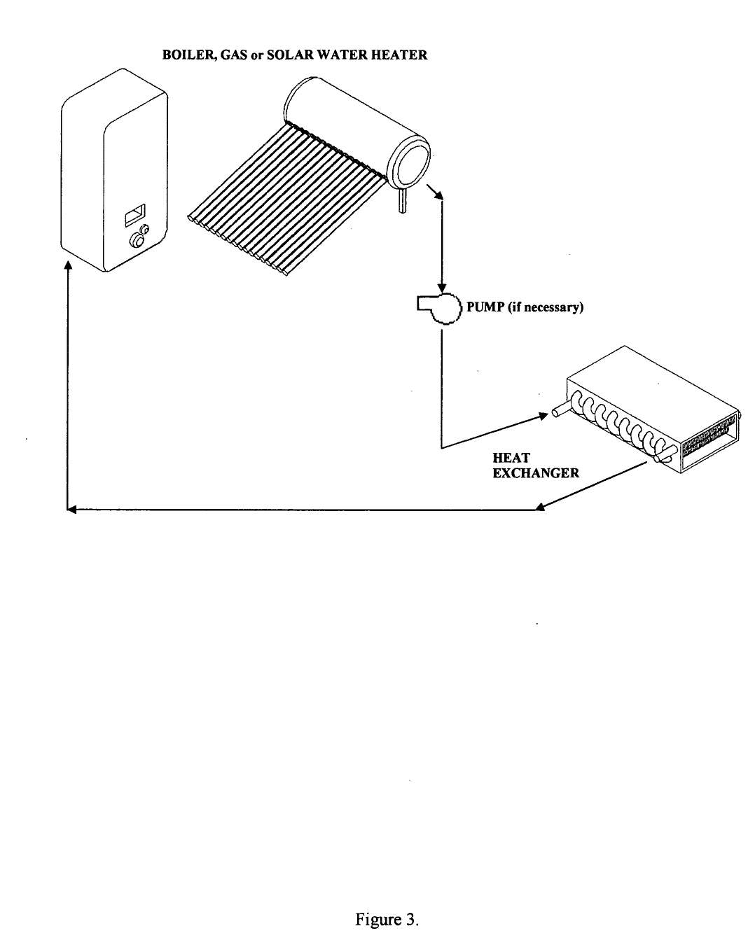

This improvement will make possible the use of solar energy to serve as the heat source of the clothes dryer by means of a solar water heater that will provide the hot water to keep low electric energy consumption. When using a Solar Water Heater, a pump within the clothes dryer will draw water from the heater's reservoir to feed the heat exchanger. No water will be consumed because the water will circulate between the Hot Water Reservoir and the clothes dryer in a closed loop (FIG. 3).

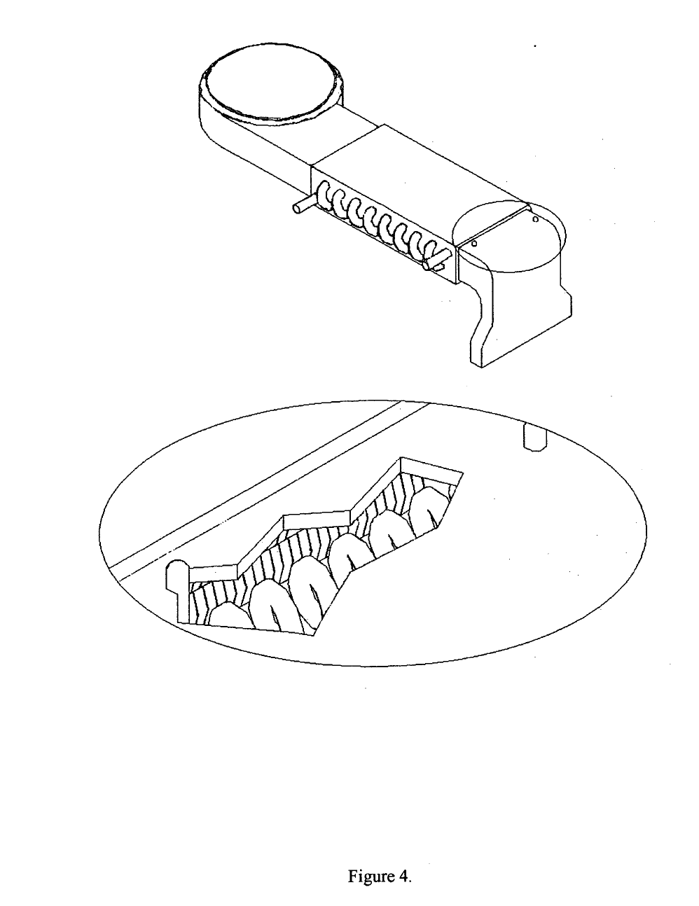

The electric resistance will remain part of the machine to serve as a back up heat source if any problems with the hot water service occurs or weather conditions are not suitable to elevate the water temperature to the working temperature that is at least 125° F. (50° C.) (FIG. 4). The electric coil and heat exchanger can be used at the same time to work as a hybrid machine to reduce the drying time.

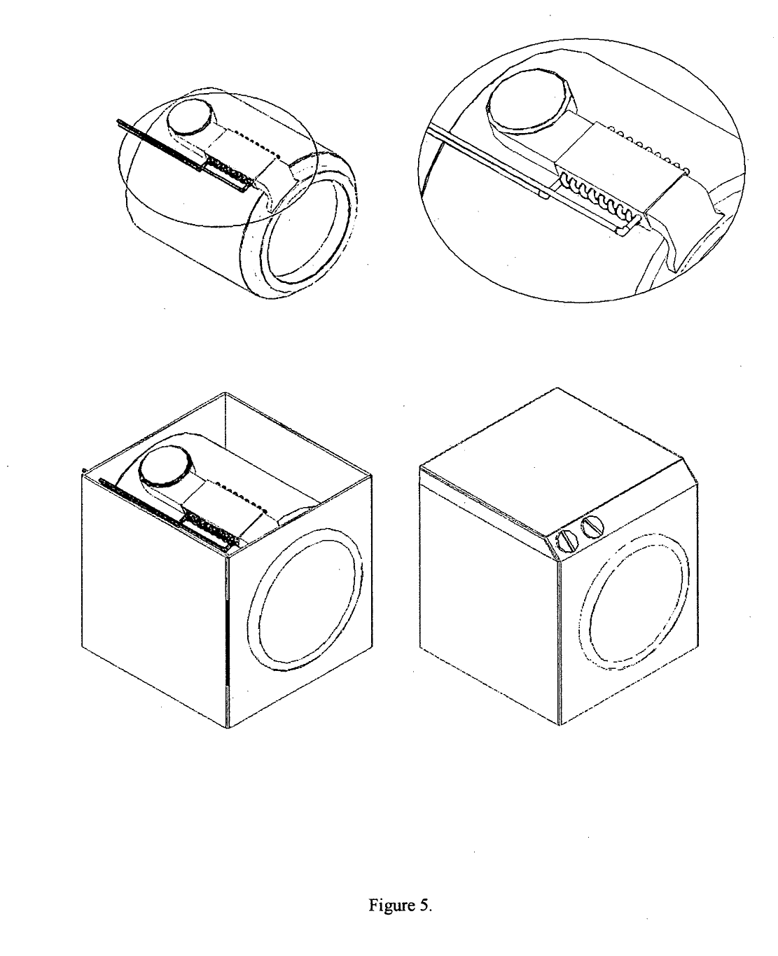

As this invention is an improvement of an electric clothes dryer, all components are within the same unit (FIG. 5).

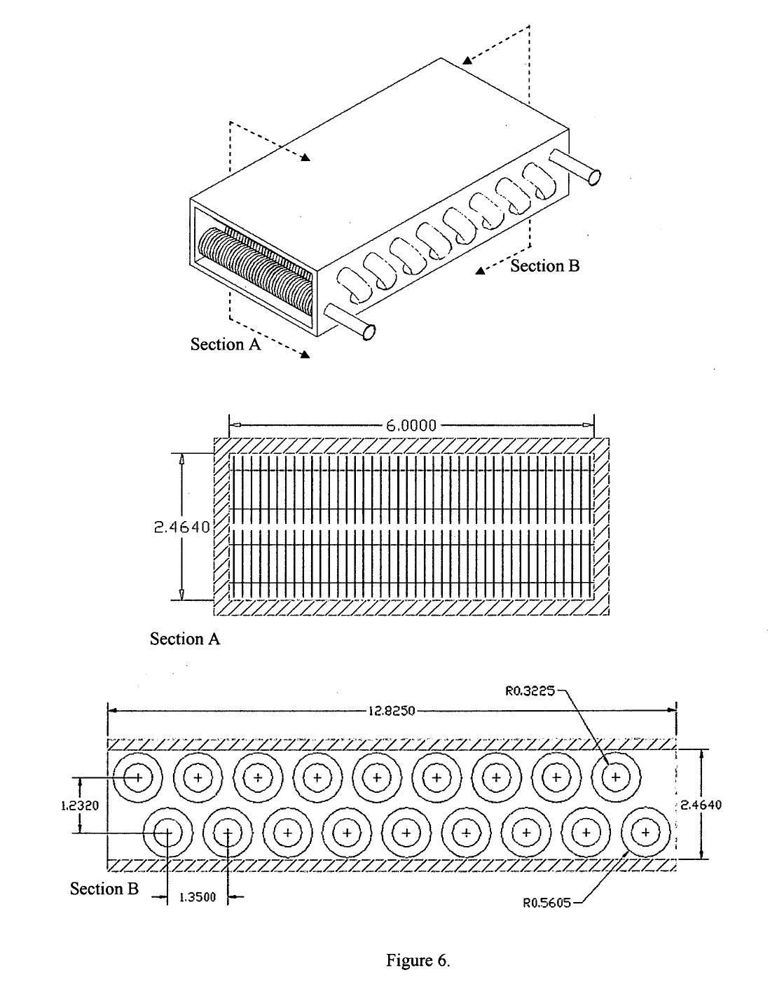

Calculations for a heat exchanger have been made to substitute an electric coil of 1500 W, giving the following results. Dimensions of the compact heat exchanger are shown in FIG. 6 and the surface used for calculations was CF 7.0-5/8 J. All values of the heat exchanger elements are in inches. Materials of heat exchanger are aluminum and copper piping.

| Outlet air temperature to drum | 115° F., 46° C. |
|---|---|
| Water flow in the heat exchanger | 562 lbm/hr |
| Pressure drop in the heat exchanger | 5 psi |
| Blower CFM's | 130 cfm |
| Number of finned tubes | 18 |

Nevertheless, other heat exchangers can be used to meet the heat required by the electric resistance. Assembly of this improvement is not difficult. Any solar water heater can be used for this purpose meaning that making the necessary piping connections the solar heater can be suitable to the improvement.

1. An improvement of a Blower-Resistance configuration to a Blower-Heat Exchanger-Resistance configuration in a domestic electric clothes Dryer comprising:
an air blower.
a compact heat exchanger capable to provide the heat input of the electric resistance, with dimensions as stated in drawings if the electric resistance has a value of 1500 W or, nevertheless, can be redesign to provide any other resistance value.
an electric resistance.

2. The same improvement can be made to other domestic appliances that use an electric resistance to heat air such as a dish washer.
